(19) United States
(12) Patent Application Publication
(10) Pub. No.: US 2004/0194657 A1
(43) Pub. Date: Oct. 7, 2004

(54) Fire-retardant coating, method for producing fire-retardant building materials

(76) Inventor: Thomas Lally, Oak Brook, IL (US)

Correspondence Address: Thomas J. Lally, 603 Mallard Lane, Oak Brook, IL, 60523, US

(21) Appl. No.: 10/818,268

(22) Filed: Apr. 5, 2004

Related U.S. Application Data
(63) Continuation-in-part of application No. 10/685,214, filed on Oct. 14, 2003.
Application No. 10/685,214 is a continuation-in-part of application No. 10/338,425, filed on Jan. 8, 2003.
Application No. 10/338,425 is a division of application No. 09/602,067, filed on Jun. 22, 2000, now Pat. No. 6,533,821.

(51) Int. Cl. C09D 5/16; C09D 5/18; C09K 3/00

(52) U.S. Cl. 106/18.12; 106/18.14; 252/607; 252/609

(57) ABSTRACT

The present invention relates to a fire-retardant material. More specifically, the present invention relates to a fire-retardant coating that shields underlying substrates from thermal insult, and a method for making such fire-retardant composition. The invented coating is especially applicable to cellulose-based building materials including but not limited to fiberboards, wallboards, roofing materials, particleboards, ceiling tiles, soundproofing boards and hardboards. The present composition is also useful in providing a fire-resistant coating for concrete, metals, foamed polymeric materials, gypsum and other building materials. The composition generally comprises: a phosphate, a metal oxide, a silicate, a silica containing filler and water.

### RELATION TO OTHER APPLICATIONS

The present application is a Continuation-In-Part of, and seeks priority to, U.S. patent application Ser. No. 10/685,214 filed Oct. 14, 2003, which is a Continuation-In-Part of, and seeks priority to U.S. patent application Ser. No. 10/338,425 filed Jan. 8, 2003, which is a divisional of U.S. patent application Ser. No. 09/602,067, filed Jun. 22, 2000, now U.S. Pat. No. 6,533,821, all of which are hereby incorporated by reference in their entireties.

### FIELD OF INVENTION

The present invention relates to a fire-retardant material. More specifically, the present invention relates to a fire-retardant coating that shields underlying substrates from thermal insult. The invented coating is especially applicable to cellulose-based building materials including but not limited to fiberboards, wallboards, roofing materials, particleboards, ceiling tiles, soundproofing boards and hardboards. This novel composition is also useful in providing a fire-resistant coating for concrete, metals, foamed polymeric materials, gypsum and other building substrates.

### BACKGROUND OF THE INVENTION

Cellulose-based products made from cellulosic fibers, chips and shavings make up a significant portion of the building product market because they are cost effective and easy to work with. Cellulose-based products provide structural support, act as roofing substrates, and even dampen unwanted noise. Unfortunately, untreated cellulose-based products are particularly susceptible to flame and thermal damage because they are composed of flammable fibers or particles. A number of coatings have been developed to reduce the flammability of such materials, but too often these methods are inadequate at providing fire-retardancy, are too expensive, produce toxic-off gas or smoke under continued exposure to flame, or have some other shortcoming.

For example, U.S. Pat. No. 5,035,851, issued to Dimanshtaeyn describes a fire-resistant coating comprising: a silicate, a clay and some inorganic materials (e.g. a borate) which can be used to coat metals, woods and foamed polymeric materials to impart some degree of fire resistance thereto. This is a complicated and expensive solution and acceptable resistance to fire is not always achieved.

A need exists for fire-retardant coating for building materials that is cost effective, non toxic and which provides superior fire-retardancy.

### SUMMARY OF THE INVENTION

An object of the present invention is to provide a heat and flame resistant coating that overcomes many of the disadvantages of the prior art.

Another object of the present invention is to provide a light-weight formulation to coat building materials. A feature of the formulation is that it thermally insulates building materials from heated fluids having high temperatures. An advantage of the invention is that it provides superior thermal and flame protection at a cost effective price.

Yet another object of the present invention is to provide a ceramic-based film which can be use to impart thermal and structural integrity to an underlying substrate. A feature of the film is it ability to impart structural rigidity to the substrate while also increasing heat and flame resistance.

Another aspect of the invention is the ability of the present composition to impregnate and/or coat the substrate to which it is applied.

Briefly, the invention provides for a fire-resistant coating comprising a phosphate compound, a metal oxide, a silica containing filler, a silicate and water.

A range of the constituents can be used. For example, the coating generally comprises: between 15-45 weight percent phosphate (i.e. mono-potassium phosphate), 5-35 weight percent metal oxide (i.e. MgO), 15-45 weight percent silica containing filler (i.e. SiO₂), 10-45 weight percent metal silicate (i.e. CaSiO₃) and 15-35 weight percent water.

### DETAILED DESCRIPTION OF THE INVENTION

The invented refractory coating and the method for producing the coating confers enhanced flame and heat resistance to building materials. Exemplary materials include steel, various ferrous and non-ferrous metals, woods, gypsums, composites of wood and cellulose, concrete, mortars, and synthetic products, including plastics, paper and carbon composites. The present invention is especially suited for coating cellulose or cellulose based building materials like fiberboards, particleboards, and medium density fiberboard (MDF).

The refractory composition generally comprises the following: a metal oxide, a phosphate, a silica containing filler, a silicate, and water. A preferred formulation of the fire-retardant coating includes the following:

Formulation I

| | |
|---|---|
| KH₂PO₄ (“MKP”) | 40 weight percent of the dry mixture |
| MgO | 20 weight percent of the dry mixture |
| SiO₂ (“silica powder”) | 30 weight percent of the dry mixture |
| CaSiO₃ | 10 weight percent of the dry mixture |

Water is added at 30 weight percent of the dry mixture.

In a preferred embodiment the MKP, MgO, SiO₂, and CaSiO₃ are mixed together in powder form to create a homogeneous dry mixture. Obtaining a homogenous dry mixture can be accomplished through a number of techniques well known in the art including ribbon mixing. See, U.S. patent application Ser. No. 09/602,067, now U.S. Pat. No. 6,533,821 filed by instant inventor on Jun. 22, 2200, and incorporated herein by reference in its entirety.

The dry mixture is mixed with water to form a slurry. In Formulation I, water is added at 30 weight percent of the dry mixture, however, water can be added at between 15 and 55 weight percent of the dry mixture. A suitable temperature range for the water is between 40-90° F. The temperature of the water is directly related to the mixture's reactivity, thus the rate of the reaction can be controlled to some degree by the temperature of the water being added. Hotter water tends to speed up the reaction while cool water tends to slow it down. It should be noted that the temperature of all other reagents in the present invention were at approximately room temperature (˜68° F.), although reagents having different temperatures can be used. The temperature of the reagents, like that of water, affects the reactivity of the slurry. Hotter reagents tend to speed up the reaction while cool reagents tend to slow it down.

The slurry is mixed until a homogeneous slurry is obtained. Suitable mixing times for most applications are between 30 seconds and 10 minutes. Mixing can be achieved using several techniques well known in the art including but not limited to mixing by hand and using an electronic hand mixer. The slurry is produced at the user site. Alternatively, the dry mixture and water can be mixed using various spray technologies where the water and dry mixture are mixed prior to, or after release from the spraying apparatus. Other mixing techniques and composition preparations can also be envisioned.

While the above-mentioned formulation and weight percents are the most preferred proportions, a range of the constituents can also used. The following weight percents are based on the weight of the combined dry mixture. For example, between approximately 20-50 weight percent mono potassium phosphate (“MKP”) can be utilized. The MgO can be utilized in a weight percent between 10-40 percent. Between approximately 20-50 weight percent silica powder can be utilized, while the silicate is suitably present in a weight percent between approximately 1-50 weight percent. The weight ratio of the MKP to MgO should be between 1:1 and 3:1, preferably at a weight ratio of approximately 2:1.

### Dry Mixture Components

One salient feature of the present invention is a metal oxide. MgO is the preferred metal oxide, however, other metal oxides may be used including but not limited to: alkali metal and alkali earth metal oxides, iron oxide, aluminum oxide, zinc oxide and combinations thereof. Preferably the MgO is light burned and is a powder having a particle size of between 30-200 microns.

Another salient feature of the present composition is a phosphate compound, preferably mono potassium phosphate (“MKP”). Other phosphates including: alkali or alkali earth metal phosphates, mono-ammonium phosphate, diammonium phosphate, phosphoric acid, aluminum phosphate, and combinations thereof can also be used. Preferably the MKP is a tech grade powder or granule with a particle size between 30-100 microns.

The silicate of the present invention is preferably CaSiO₃. Other silicates can be used including: alkali metal and alkali earth metal silicates, aluminum silicate, alumina silicate, alumino silicate, magnesium silicates, talc and combination thereof. A suitable silicate is VANSIL® W-10 from R.T. Vanderbilt Company (Norwalk, Conn.).

The invented composition calls for a silica containing filler. Preferably, the filler has a silica content of 60% or greater. It is also preferable to have a filler having a particle size of approximately 30 microns or less. The silica containing filler is preferably silica powder. Other silica containing compounds including but not limited to: silica fume, rice hull ash, fly ash, granite dust, volcanic glasses, kyanite, mullite, sand, clay, cenospheres, bauxite, and mixtures thereof can also be employed in addition to, or in place of, silica powder.

### Alternate Embodiments

Various alternate embodiments are illustrated below. These embodiments are exemplary and are not meant to limit the scope of the invention.

Formulation II

| | |
|---|---|
| MKP | 40 weight percent of the dry mixture |
| MgO | 35 weight percent of the dry mixture |
| SiO₂ | 20 weight percent of the dry mixture |
| CaSiO₃ | 5 weight percent of the dry mixture |

Water is added at between 15 and 55 weight percent of the dry mixture. Preferably water is added at approximately 30 weight percent of the dry mixture.

It was found that the addition of rice hull ash to the mixture produced a coating with superior bonding and fire-retardancy properties. An exemplary formulation of this embodiment is shown below:

Formulation III

| | |
|---|---|
| MKP | 35 weight percent of the dry mixture |
| MgO | 17 weight percent of the dry mixture |
| SiO₂ | 28 weight percent of the dry mixture |
| CaSiO₃ | 10 weight percent of the dry mixture |
| Rice Hull Ash | 10 weight percent of the dry mixture |

Water is added at between 15 and 55 weight percent of the dry mixture. Preferably water is added at approximately 30 weight percent of the dry mixture.

It was also found that the silicate could be substituted by a calcium phosphate, preferably, tricaclium phosphate. An exemplary formulation of this embodiment is shown below:

Formulation IV

| | |
|---|---|
| MKP | 40 weight percent of the dry mixture |
| MgO | 20 weight percent of the dry mixture |
| SiO₂ | 35 weight percent of the dry mixture |
| Tri-calcium | 5 weight percent of the dry mixture |
| Phosphate (TCP) | |

Water is added at between 15 and 55 weight percent of the dry mixture. Preferably water is added at approximately 35 weight percent of the dry mixture.

In an alternate embodiment silica sand was added to the formulation imparting a harder coating with improved structural qualities.

Formulation V

| | |
|---|---|
| MKP | 20 weight percent of the dry mixture |
| MgO | 10 weight percent of the dry mixture |
| SiO₂ | 15 weight percent of the dry mixture |
| CaSiO₃ | 5 weight percent of the dry mixture |
| Silica Sand | 50 weight percent of the dry mixture |

Water is added in between 15 and 55 weight percent of the dry mixture. Preferably water is added at approximately 35 weight percent of the dry mixture. When the above-mentioned formulations it may be helpful to blow heated air (i.e. 120° F.) onto the surface of the finished product to encourage setting.

Various charring agents (i.e. starch) can be added to the present invention to provide additional fire protection. The charring agents form another layer of protection when exposed to flame. Such charring agents are especially important if the composition is being used to make a intumescent paint or coating.

### Application of Fire-Retardant Slurry

The compositions of the present invention can be applied to building substrates by any technique well known in the art including but not limited to: spraying, rolling, brushing, dripping, painting, trolling, and dip coating. The techniques will vary according to desired results. When applied to cellulose based (or other fibrous) materials the composition impregnates and/or forms a coating on the substrate. Impregnation will increase if the slurry is applied to the substrate while it is still in a semi-wet or doughy state.

The setting time of the slurry will depend on a number of factors including reagent and water temperatures and slurry thickness. The slurry will generally cure faster with increased thickness. High temperature reagents will tend to speed up the slurry reaction and cause it to cure at an increased rate. Curing will result in a hardened, fire-resistant coating upon the substrate.

Having described the basic concept of the invention, it will be apparent to those skilled in the art that the foregoing detailed disclosure is intended to be presented by way of example only, and is not limiting. Various alterations, improvements, and modifications are intended to be suggested and are within the scope and spirit of the present invention. Additionally, the recited order of the elements or sequences, or the use of numbers, letters or other designations therefore, is not intended to limit the claimed processes to any order except as may be specified in the claims. Accordingly, the invention is limited only by the following claims and equivalents thereto.

All publications and patent documents cited in this application are incorporated by reference in their entirety for all purposes to the same extent as if each individual publication or patent document were so individually denoted.

I claim the following:

1. A fire-retardant composition comprising the following:
a phosphate, a metal oxide, a metal silicate, a silica containing filler; and water,
wherein the weight percent ratio of the phosphate to metal oxide is between 1:1 and 3:1.

2. The fire-retardant composition of claim 1, further comprising a charring agent present at between 1-20 weight percent.

3. The fire-retardant composition of claim 1, further comprising silica sand present at between 5-50 weight percent.

4. The fire-retardant composition of claim 1, wherein the phosphate is selected from the group consisting of: alkali or alkali earth metal phosphates, mono-ammonium phosphate, diammonium phosphate, phosphoric acid, aluminum phosphate, and combinations thereof.

5. The fire-retardant composition of claim 1, wherein the phosphate is mono-potassium phosphate.

6. The fire-retardant composition of claim 1, wherein the metal oxide is selected from the group consisting of: alkali metal and alkali earth metal oxides, iron oxide, aluminum oxide, zinc oxide and combinations thereof.

7. The fire retardant composition of claim 1, wherein the metal oxide is MgO.

8. The fire retardant composition of claim 1, wherein the silicate is selected from the group consisting of: alkali metal and alkali earth metal silicates, aluminum silicate, alumina silicate, alumino silicate, magnesium silicates, talc and combinations thereof.

9. The fire retardant composition of claim 1, wherein the silicate is CaSiO₃.

10. The fire retardant composition of claim 1, wherein the silica containing filler is selected from the group consisting of: silica powder, silica fume, rice hull ash, fly ash, granite dust, volcanic glasses, kyanite, mullite, sand, clay, cenospheres, ceramicspheres, bauxite, and mixtures thereof.

11. The fire retardant composition of claim 1, wherein the silica containing filler is silica powder.

12. The fire retardant composition of claim 1, wherein the weight ratio of the phosphate to metal oxide is approximately 2:1.

13. The fire retardant composition of claim 1, wherein the phosphate is present at approximately 32 weight percent.

14. The fire retardant composition of claim 1, wherein the metal oxide is present at approximately 15 weight percent.

15. The fire retardant composition of claim 1, wherein the silicate is present at approximately 7 weight percent.

16. The fire retardant composition of claim 1, wherein the silica containing filler is present at approximately 22 weight percent.

17. The fire retardant composition of claim 1, wherein water is present at approximately 24 weight percent.

18. A fire-retardant composition comprising the following:
a phosphate at between 15-45 weight percent;
a metal oxide at between 5-35 weight percent;
a silica containing filler at between 15-45 weight percent;
a metal silicate at between 1-45 weight percent; and
water at between 15-35 weight percent.

19. A fire-retardant composition comprising the following:
a phosphate, a metal oxide, a calcium containing compound;
a silica containing filler, and water;
wherein the weight ratio between the phosphate and the metal oxide is between 1:1 and 3:1.

20. A fire-retardant composition of claim 19 wherein the calcium containing compound is tri-calcium phosphate.

21. A fire-retardant comprising:
a) a means for providing fire-retardancy to a substrate,
wherein the fire-retardant is derived from a mixture of KH₂PO₄, a metal oxide, a metal silicate, a silica containing filler and water, where the weight ratio between KH₂PO₄the metal oxide is between 1:1 and 3:1.

22. A fire-retardant described in claim 19, wherein the substrate is cellulose-based.

23. A fire-retardant described in claim 19, wherein the substrate is selected from the group consisting of: steel, ferrous metals, non-ferrous metals, woods, gypsums, wood composites, concrete, mortars, synthetics products, paper, carbon composites, foamed polymeric materials and combinations thereof.
